(19) United States
(12) Patent Application Publication
(10) Pub. No.: US 2006/0027390 A1
(43) Pub. Date: Feb. 9, 2006

(54) Bus bar

(75) Inventors: Tatsuo Suzuki, Yokkaichi-City (JP); Shinshu Kato, Yokkaichi-City (JP); Hiroyuki Nakata, Yokkaichi-City (JP); Ingyu Paku, Yokkaichi-City (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 11/196,274

(22) Filed: Aug. 4, 2005

(30) Foreign Application Priority Data
Aug. 5, 2004 (JP) 2004-229937

(51) Int. Cl. H02G 5/00

(52) U.S. Cl. 174/68.2

(57) ABSTRACT

To suppress a temperature-rise in and to improve the quality of a bus bar when a desired width for the bus bar is not ensured, a bus bar is formed by stamping from a conductive metal plate of a predetermined thickness. The bus bar is configured to be included in an electric junction box for installation in an automobile. The bus bar includes a main bus bar formed by stamping from a conductive metal plate according to a circuit pattern and an auxiliary bus bar that is laminated and firmly fixed at a location on the main bus bar where the main bus bar cannot be stamped with a desired width. The auxiliary bus bar is fixed to the main bus bar, for example, by welding, to form an integrated combination. At the welded portion of the integrated combination, the width of the main bus bar or the width of the auxiliary bus bar is no greater than other portions.

### CROSS-REFERENCE TO RELATED APPLICATIONS

The present disclosure relates to subject matter contained in priority Japanese Application No. 2004-229937, filed on Aug. 5, 2004, which is herein expressively incorporated by reference in its entirety.

### BACKGROUND OF THE INVENTION

1. Field of the Invention

The present invention relates to a bus bar to be included in an electric junction box for installation in an automobile. Specifically, the present invention enables disposing bus bars in high-density on an insulating plate of a predetermined size, while suppressing a rise in temperature.

2. Description of Related Art

An electric junction box for installation in an automobile often includes bus bars as internal circuits. The bus bars are formed by stamping from a conductive metal plate according to a circuit pattern. In recent years, in accordance with a sharp increase in the number of electronic components installed in an automobile, disposition of bus bars in an electric junction box also becomes more crowed, thereby making it difficult to ensure a sufficient width for a bus bar.

On the other hand, a temperature-rise in a bus bar due to a flow of electric current in the bus bar depends on the electric resistance of the bus bar, that is, depends on the cross-section area of the bus bar, when the electric current value and the material of the bus bar are the same.

Bus bars disposed on one insulating plate are formed by stamping out from one conductive metal plate, so that the thickness of the bus bars is uniform. Therefore, by ensuring a sufficient width for the bus bars according tbt the value of an electric current, it is possible to suppress a temperature rise in the bus bars.

Therefore, it is possible to suppress over-heating by enlarging the width of the bus bars forming a large-current u nit. However, as mentioned above, bus bars are disposed in high-density; therefore, it is often impossible to enlarge the width of the bus bars forming the large-current portion of a circuit to a required extent.

To address the above-described problem, various solutions have been proposed for suppressing a temperature-rise without extending the width a bus bar. For example, in Japanese Laid-Open Patent Publication No. 2000-151149, as FIG. 9 of the present application shows, at a required position on pattern portion 1 of a bus bar, a welded member 2, having a heat sink 2a positioned vertically relative to pattern portion 1 and welded portion 2b positioned parallel to pattern portion 1, is firmly fixed by laser welding, thereby increasing the surface area and permitting heat to move efficiently.

However, since heat sink 2a is fixed on pattern portion 1 and extends upwardly, this may cause constraints in design and reduce the flexibility in the layout of an electric junction box. Further, using welded member 2 having a large surface area can also cause increases in weight and material cost.

### SUMMARY OF THE INVENTION

The present invention is provided to address the above-described problems. Some objectives of the present invention is to provide a bus bar having configuration to suppress a temperature-rise, which, even for locations on the bus bar where sufficient width for the bus bar cannot be ensured, has fewer design constraints, can be made light-weight, and has a stability quality.

In order to achieve the above-mentioned objectives according to one aspect of the present invention, a bus bar is provided which is formed by stamping a conductive metal plate of a predetermined thickness, that is to be included in an electric junction box for installation in an automobile. The bus bar includes a main bus bar that is formed by stamping from a conductive metal plate according to a circuit pattern, and an auxiliary bus bar that is laminated and firmly fixed at a location on the main bus bar where the main bus bar cannot be stamped to a desired width. The auxiliary bus bar is fixed to the main bus bar in any suitable manner, for example, by welding, thereby forming an integrated combination, and at the welded portion of the integrated combination, the width of the main bus bar or the width of auxiliary bus bars is no greater than other parts of the bus bar.

In another aspect of the present invention, a protrusion is formed at the welded portion of the auxiliary bus bar or the main bus bar and a recess is formed on two sides or one side of the protrusion, thereby forming the narrow-width portion of the bus bar. The recess is configured even when the recess is filled with molten metal occurring during the welding, the width of this portion of the bus bar is still no greater than the other parts of the bus bar.

According to a further aspect of the present invention, a bus bar is provided for use in an electric junction box configured to be installed in an automobile, the bus bar including a main bus bar formed by stamping from a conductive metal plate and an auxiliary bus bar laminated on the main bus bar at a location where the main bus bar cannot be stamped from the conductive metal with a desired width, wherein the auxiliary bus bar is fixed to the main bus bar at a predetermined position to form an integrated combination, and wherein the width of the main bus bar or of the auxiliary bus bar is no greater than other portions at the predetermined location.

In still another aspect of the present invention, a protrusion may be formed on the auxiliary bus bar or on the main bus bar at the predetermined location, and a recess may be formed on either one or both sides of the protrusion, thereby forming the narrow width, and the recess is configured such that, even when the recess is filled with displaced material occurring during the fixing, the width of this portion of the bus bar remains no greater than other portions.

According to another aspect of the present invention, an insulating plate having a recess may be provided, the auxiliary bus bar may be fixed to an undersurface of the main bus bar forming the integrated combination, and the auxiliary bus bar may be fitted in the recess of the insulating plate so that the surface of the welded portion of the main bus bar is maintained at generally the same height as other parts of the main bus bar.

In another aspect of the present invention, the auxiliary bus bar may be fixed to the main bus bar by welding.

In still another aspect of the present invention, an insulating plate may be provided that has a pair of guide ribs that extend from the insulating plate to a distance as high as the lamination of the bus bar and the auxiliary bus bar so that adjacent bus bars are separated from each other to ensure insulation.

According to a further aspect of the present invention, a method of forming a laminated bus bar includes stamping a main bus bar from a conductive metal plate, stamping an auxiliary bus bar to a predetermined length from a conductive metal plate, laminating the auxiliary bus bar to the main bus bar at a location where the main bus bar cannot be stamped from the conductive metal plate with a desired width, and fixing the auxiliary bus bar to the main bus bar at a predetermined location along the length-wise direction of the auxiliary bus bar to form an integrated combination, such that the width of the main bus bar or of the auxiliary bus bar is no greater than other portions at the predetermined location.

In another aspect of the present invention, the method may include forming a protrusion generally at the center of the auxiliary bus bar or the main bus bar; and forming a recess to extend inwardly of one or both sides along the width-wise direction of the respective bus bar, wherein widths of other parts other than the fixed portion are no greater than the width of a laminated portion of the main bus bar.

In still another aspect of the present invention, the fixing may be performed by welding. The protrusion may be melted and welded to the main bus bar, such that molten metal flows into the recess, and the protrusion may be configured such that the molten metal flowing into the recess will not protrude beyond the width of the main bus bar.

In still further aspects of the present invention, the method may include forming the protrusion on the auxiliary bus bar, and forming the recess that molten metal flows into on the auxiliary bus bar. Alternatively, the method may include forming the protrusion on the main bus bar, and forming the recess that molten metal flows into on the main bus bar.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1 is a schematic cross-sectional diagram of an electric junction box of the present invention;

FIG. 2 is a top plan view of a bus bar to be provided in the electric junction box of FIG. 1;

FIG. 3 is a schematic cross-sectional diagram illustrating a fixing condition between the bus bar and an insulating plate;

FIG. 4 (A) is a top plan view of an auxiliary bus bar of FIG. 1;

FIG. 4 (B) is a cross-sectional view of the auxiliary bus bar of FIG. 4 (A);

FIG. 5 (A) is a top plan view of a laminated portion between the bus bar and the auxiliary bus bar with the main parts enlarged;

FIG. 5 (B) is a cross-sectional view through line B-B of the laminated portion between the bus bar and the auxiliary bus bar;

FIG. 5 (C) is a cross-sectional view of the bus bar and auxiliary bus bar of FIG. 5 (A) and (B);

FIG. 6 (A) is an oblique prospective view of the main parts at which bus bars of the present invention are located;

FIG. 6 (B) is a cross-sectional view through line B-B of FIG. 6 (A);

FIG. 7 is a schematic oblique perspective diagram of a second embodiment of the present invention;

FIG. 8 is a cross-sectional view of the second embodiment; and

FIG. 9 is a prior art bus bar.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

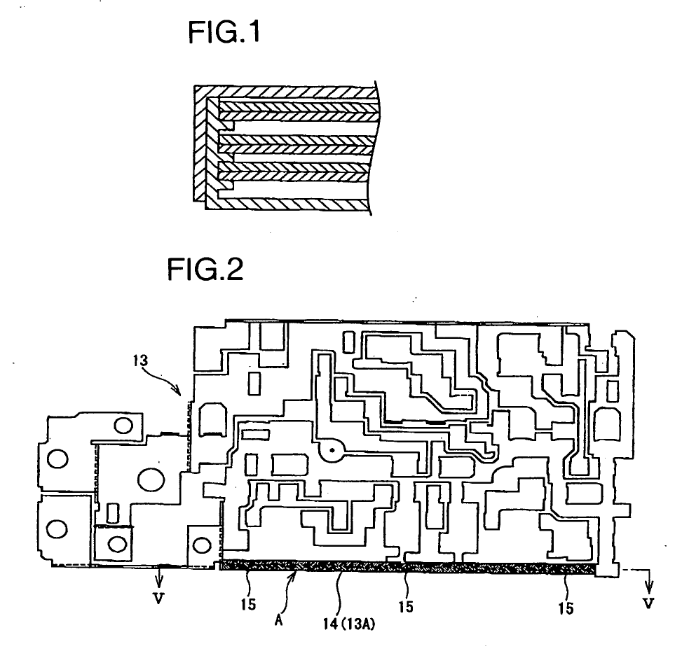

The following describes preferred embodiments of the present invention with reference to the drawings. FIG. 1 through 6 illustrate automotive electric junction box 10 according to the first embodiment of the present invention. Electric junction box 10 includes a case made of lower case 21 and upper case 20. Within the case, circuit material fixed with bus bar 12 are laminated on insulating plate 11 in a stacked configuration.

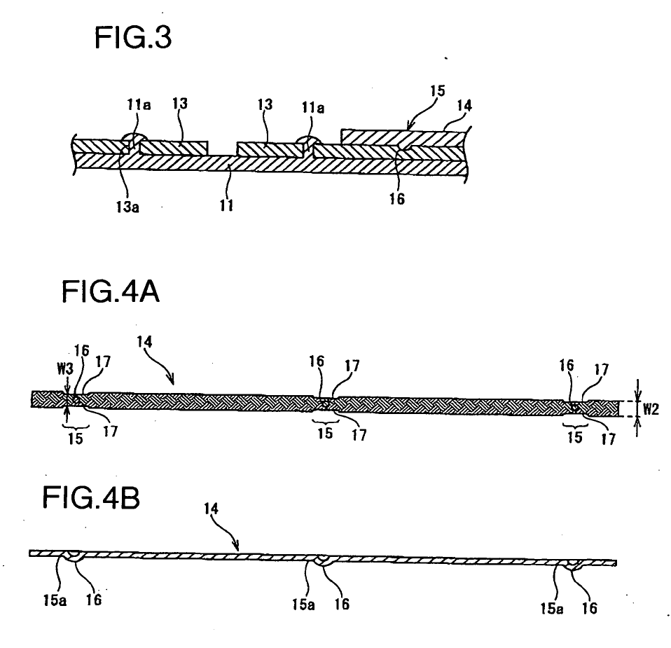

FIG. 2 illustrates bus bar 12 mounted on one insulating plate. Bus bar 12 forms main bus bar 13 by stamping out from one conductive metal plate with equal thickness in accordance with circuit patterns, thereby mounting main bus bar 13 on the upper surface of insulating plate 11. Main bus bar 13, as shown in FIG. 3, has small hole 13a formed at predetermined positions. Rib 11a extends from insulating plate 11, penetrates small hole 13a, and its end is crimped tight against bus bar 13.

Main bus bar 13 has separate auxiliary bus bar 14 laminated firmly on the upper surface of a predetermined position of 13A, which corresponds to large current portion A (shaded area of FIG. 2), which faces the power supply circuit connected to the input terminal side of a fuse (not shown in the drawings), for example.

Auxiliary bus bar 14, as shown in FIGS. 4 (A) and (B) is stamped out from a conductive metal plate having a thickness generally identical to that of main bus bar 13 so that its length is identical to that of 13 A, the predetermined portion of main bus bar 13. In this example, auxiliary bus bar 14 has a fixed portion 15 at three locations along its length direction: in the center and near the two ends. However, any number of fixed portions may be provided, depending upon the length of the bus bar, for example. Furthermore, fixed portion 15 may be provided in any suitable manner, for example by use of adhesive or by a suitable welding process. Besides fixed portion 15, auxiliary bus bar 14 has width W2, which is the same as with W1 of predetermined portion 13A of the main bus bar. A small protrusion 16 is provided generally at the center of the fixed side 15a of fixed portion 15. In addition, a recess 17 is formed at opposite sides of the bus bar 14 centering generally about small protrusion 16 and symmetrically in the width direction. Width W3 of fixed portion 15 is smaller than width W1 of predetermined portion 13A of the main bus bar. Recess 17 is provided to contain molten metal when protrusion 16 is resistance welded. Therefore, the volumetric capacity of recess 17 is designed to contain the total amount of molten metal, thereby preventing any portion from protruding from the surface.

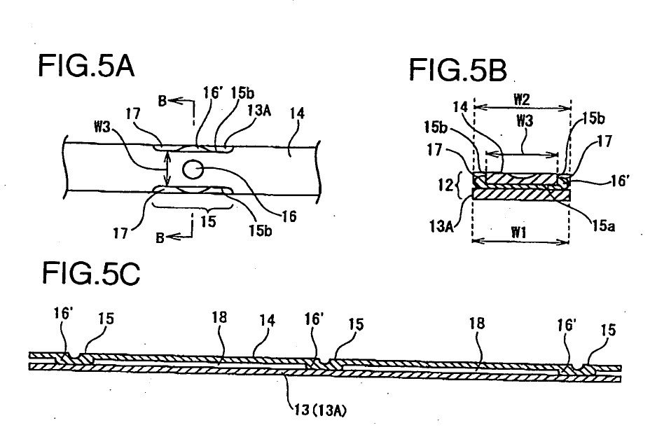

As shown in FIGS. 5 (A), (B), and (C), auxiliary bus bar 14 is attached to the upper surface of the predetermined portion 13A of main bus bar 13 by fixing protrusion 16 of fixed portion 15 to main bus bar 13 through, for example, resistance welding.

As described above, auxiliary bus bar 14 fixed to large current portion A, as for example by welding, enlarges the cross-sectional area of bus bar 12 with its laminated portion, thereby preventing a temperature rise due to a large current discharge. Furthermore, as shown in FIGS. 5 (A) and (B), although molten metal 16′ runs over the width of fixed portion 15 of auxiliary bus bar 14, it is contained within recess 17. Therefore, since auxiliary bus bar 14 does not extend past the outer shape of predetermined portion 13A of main bus bar 13, including molten metal 16′, it is possible to prevent molten metal 16′ from accidentally contacting an adjacent circuit bus bar to cause short circuit. Further, as shown in FIG. 5 (B), molten metal 16′ is welded firmly, enclosed by welding side 15a and the two sides 15b of fixed portion 15 of auxiliary bus bar 14, thereby increasing the fixing strength between main bus bar 13 and auxiliary bus bar 14 and improving the stability quality. In addition, auxiliary bus bar 14 is laminated on the surface of main bus bar 13 without exceeding its width, thereby eliminating the need to change the size of the one-layer insulating plate. This makes it possible to easily implement the present invention without affecting the outer shape and the like of electric junction box 10.

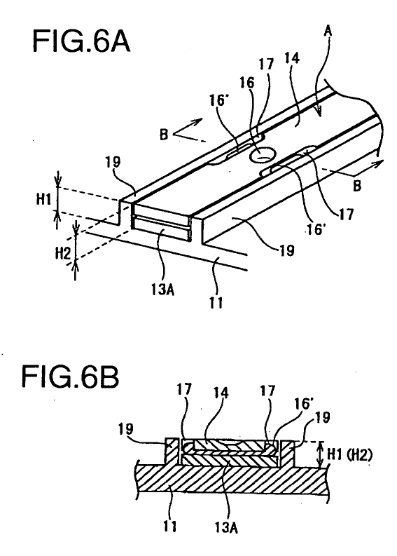

As shown in FIGS. 6 (A) and (B), the location where auxiliary bus bar 14 is laminated onto main bus bar 13 is set between a pair of guide ribs 19 extending from insulating plate 11. The height H1 of guide rib 19 is generally the same as the height H2 of the lamination of predetermined portion 13 A of the main bus bar and auxiliary bus bar 14.

As described above, since both sides of large current portion A are guided by guide rib 19, it is possible to prevent external pressure from affecting the welded portion between predetermined portion 13A of the main bus bar and auxiliary bus bar 14 and to prevent auxiliary bus bar 14 from coming free from the main bus bar. In addition, short circuits with bus bars in adjacent circuit can be reliably avoided.

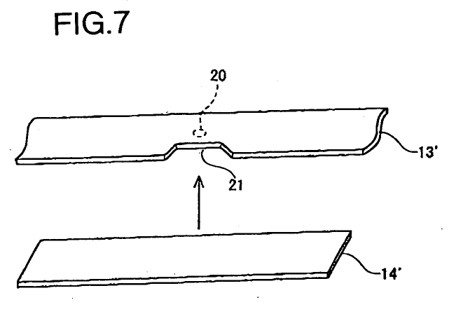

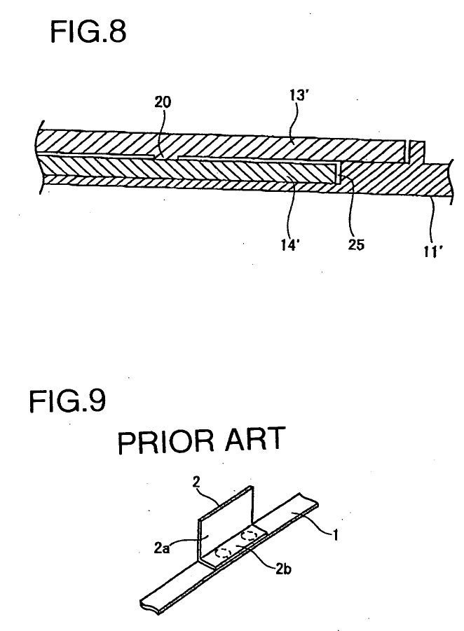

FIGS. 7 and 8 illustrate the second embodiment. In the second embodiment, a protrusion 20 for welding is provided on the welding side of main bus bar 13′. A recess 21 is provided in the width direction on one side of the part where protruding portion 20 is provided. On the other hand, no protrusion or recess is provided on auxiliary bus bar 14, whose width is identical to that of the portion of main bus bar 13′ where recess 21 is provided. In addition, unlike the first embodiment, where an auxiliary bus bar is laminated onto the upper surface of the main bus bar, auxiliary bus bar 14′ is positioned on the bottom surface of the welded portion of main bus bar 13′ in the second embodiment, uniting main bus bar 13′ and auxiliary bus bar 14′ by, for example, resistance welding at protrusion 20. Further, molten metal melted by resistance welding is contained in recess 21 that is formed on the one side of main bus bar 13′.

On the other hand, as shown in FIG. 8, a recess 25 is provided on insulating plate 11 in the welded auxiliary bus bar so that auxiliary bus bar 14′ is engaged in recess 25. As a result, the height of main bus bar 13′ is kept generally identical to that of the remaining parts.

As a method for forming the bus bars, for example, an auxiliary bus bar is stamped to a predetermined length from a conductive metal plate. A welded portion for welding to a main bus bar is formed at a predetermined location along the length-wise direction of the auxiliary bus bar. At the welded portion, a protrusion is formed generally at the center along the width-wise direction for welding to the main bus bar, and a recess is also formed by recessing inwardly two sides or one side along the width-wise direction. Widths of other parts other than the welded portion are the same as or narrower than the width of a laminate portion of the main bus bar. When the protrusion is melted and welded to the main bus bar, molten metal flows into the recess. It is configured such that the molten metal flowing into the recess will not protrude beyond the width of the main bus bar. The protrusion for welding may also be formed on the main bus bar. The protrusion for welding may also be formed on the main bus bar. And, the recess that molten metal flows into may also be formed on the main bus bar.

In the bus bar of the present invention, when the auxiliary bus bar is welded onto the upper surface of the main bar and a laminate is formed, the cross-sectional area of the laminate along the perpendicular direction becomes larger. Therefore, it is possible to suppress a temperature-rise, when an electric current is applied, and to prevent a burnout of the bus bar.

Further, the welded portion of the auxiliary bus bar (or the main bus bar) has a narrow width. Therefore, when welding, the resistance of the welded portion becomes larger, which prevents heat dispersion. As a result, the welded portion becomes easier to melt, which makes welding easier. Further, since molten metal flows into the recess, which is formed to make the bus bar narrow-width, and does not protrude beyond the width of the bus bar, it is possible to avoid accidentally touching bus bars of an adjacent circuit by the molten metal and to prevent occurrence of a short circuit.

Further, by letting the molten metal flow into the recess, the auxiliary bus bar of the welded portion is surrounded by molten metal from three directions, the welding side and the two sides, and is firmly fixed; therefore, the contact area between the auxiliary bus bar and the main bus bar is increased, thereby enhancing the fixing strength.

The auxiliary bus bar can be formed of excess portions of a conductive metal plate that are stamped from the bus bar to keep the costs down. Moreover, the generally identical thickness of the auxiliary bus bar makes it easier to control the amount of radiation heat. The thickness of the auxiliary bar does not necessarily have to be identical to that of the bus bar. Using the auxiliary bus bar results in a larger cross-sectional area, thereby improving the temperature control function. Its is also possible to laminate a plurality of bus bars whose thickness is generally identical to that of the main bus bar.

The main bus bar is fixed on the insulating plate. It is preferable that a pair of guide ribs extend from the insulating plate to a distance as high as the lamination of the bus bar and the auxiliary bus bar so that adjacent bus bars are separated from each other to ensure insulation. Instead of keeping the guide ribs high, it is also possible to fix the auxiliary bus bar on the bottom surface of the bus bar, while providing a recess in the insulating plate in which the auxiliary bus bar is engaged, thereby keeping the height of the bus bar laminated with the auxiliary bus bar generally on a par with that of the other portions.

As described above, the present invention enables effective control of a temperature rise in the bus bar when applying current by welding the auxiliary bus bar to the main bus bar without taking up an extra plane surface space, even when the bus bar does not structurally allow for an extra width required for lamination. Moreover, since molten metal does not extend past the outer shape of the bus bar at the welding locations, short circuit vulnerability can be avoided between adjacent bus bars.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention and in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

What is claimed is:

1. A bus bar formed by stamping from a conductive metal plate of predetermined thickness, the bus bar being configured to be included in an electric junction box for installation in an automobile, the bus bar comprising:
a main bus bar formed by stamping from a conductive metal plate according to a circuit pattern; and
an auxiliary bus bar laminated and firmly fixed on a location on the main bus bar where the main bus bar cannot be stamped from the conductive metal with a desired width,
wherein the auxiliary bus bar is welded to the main bus bar, forming an integrated combination, and at the welded portion of the integrated combination, a width of the main bus bar or of the auxiliary bus bar is no greater than other portions.

2. The bus bar according to claim 1, wherein a protrusion is formed at the welded portion of the auxiliary bus bar or the main bus bar and a recess is formed on two sides or one side of the protrusion, thereby forming the narrow width, and the recess is configured such that, even when the recess is filled with molten metal occurring during the welding, the width of this portion of the bus bar remains no greater than other portions.

3. The bus bar according to claim 1, wherein the auxiliary bus bar is welded to an undersurface of the main bus bar, forming an integrated combination, and the auxiliary bus bar is fitted in a recess on an insulating plate so that the surface of the welded portion of the main bus bar is maintained at generally the same height as other parts of the main bus bar.

4. The bus bar according claim 2, wherein the auxiliary bus bar is welded to an undersurface of the main bus bar, forming an integrated combination, and the auxiliary bus bar is fitted in a recess on an insulating plate so that the surface of the welded portion of the main bus bar is maintained at generally the same height as other parts of the main bus bar.

5. A bus bar for use in an electric junction box configured to be installed in an automobile, the bus bar comprising:
a main bus bar formed by stamping from a conductive metal plate; and
an auxiliary bus bar laminated on the main bus bar at a location where the main bus bar cannot be stamped from the conductive metal with a desired width,
wherein the auxiliary bus bar is fixed to the main bus bar at a predetermined position to form an integrated combination, and wherein the width of the main bus bar or of the auxiliary bus bar is no greater than other portions at the predetermined location.

6. The bus bar according to claim 5, wherein a protrusion is formed on the auxiliary bus bar or on the main bus bar at the predetermined location, and a recess is formed on either one or both sides of the protrusion, thereby forming the narrow width, and the recess is configured such that, even when the recess is filled with displaced material occurring during the fixing, the width of this portion of the bus bar remains no greater than other portions.

7. The bus bar according to claim 5, further comprising an insulating plate having a recess,
wherein the auxiliary bus bar is fixed to an undersurface of the main bus bar, forming the integrated combination, and the auxiliary bus bar is fitted in the recess of the insulating plate so that the surface of the welded portion of the main bus bar is maintained at generally the same height as other parts of the main bus bar.

8. The bus bar according to claim 6, further comprising an insulating plate having a recess,
wherein the auxiliary bus bar is fixed to an undersurface of the main bus bar, forming the integrated combination, and the auxiliary bus bar is fitted in the recess of the insulating plate so that the surface of the welded portion of the main bus bar is maintained at generally the same height as other parts of the main bus bar.

9. The bus bar according to claim 5, wherein the auxiliary bus bar is fixed to the main bus bar by welding.

10. The bus bar according to claim 6, wherein the auxiliary bus bar is fixed to the main bus bar by welding.

11. The bus bar according to claim 5, further comprising an insulating plate having a pair of guide ribs that extend from the insulating plate to a distance as high as the lamination of the bus bar and the auxiliary bus bar so that adjacent bus bars are separated from each other to ensure insulation.

12. The bus bar according to claim 6, further comprising an insulating plate having a pair of guide ribs that extend from the insulating plate to a distance as high as the lamination of the bus bar and the auxiliary bus bar so that adjacent bus bars are separated from each other to ensure insulation.

13. A method of forming a laminated bus bar, comprising:
stamping a main bus bar from a conductive metal plate;
stamping an auxiliary bus bar to a predetermined length from a conductive metal plate;
laminating the auxiliary bus bar to the main bus bar at a location where the main bus bar cannot be stamped from the conductive metal plate with a desired width; and
fixing the auxiliary bus bar to the main bus bar at a predetermined location along the length-wise direction of the auxiliary bus bar to form an integrated combination, such that the width of the main bus bar or of the auxiliary bus bar is no greater than other portions at the predetermined location.

14. The method according to claim 13, further comprising forming a protrusion generally at the center of the auxiliary bus bar or the main bus bar; and
forming a recess to extend inwardly of one or both sides along the width-wise direction of the respective bus bar,
wherein widths of other parts other than the fixed portion are no greater than the width of a laminate portion of the main bus bar.

15. The method according to claim 14, wherein the fixing is performed by welding.

16. The method according to claim 15, wherein the protrusion is melted and welded to the main bus bar, such that molten metal flows into the recess, and the protrusion is configured such that the molten metal flowing into the recess will not protrude beyond the width of the main bus bar.

17. The method according to claim 16, further comprising forming the protrusion on the auxiliary bus bar.

18. The method according to claim 16, further comprising forming the protrusion on the main bus bar.

19. The method according to claim 17, further comprising forming the recess that molten metal flows into on the auxiliary bus bar.

20. The method according to claim 18, further comprising forming the recess that molten metal flows into on the main bus bar.
